(19) United States
(12) Patent Application Publication
(10) Pub. No.: US 2012/0105603 A1
(43) Pub. Date: May 3, 2012

(54) DISPLAY SYSTEM WITH DYNAMIC 3D SOUND REPRODUCTION AND RELATED METHOD

(76) Inventors: Hsuan-Ching Liu, Tainan County (TW); Shu-Ming Liu, Tainan County (TW)

(21) Appl. No.: 12/938,344

(22) Filed: Nov. 2, 2010

(51) Int. Cl. H04N 13/00; H04R 5/00

(52) U.S. Cl. 348/51; 381/17; 348/E13.026

(57) ABSTRACT

A display system includes a video processor, an audio processor, a screen and a sound reproducing apparatus is provided. The video processor is configured to convert a 2D video signal into a 3D video signal and acquire a 3D computation power loading indicator which is associated with 3D video contents of the 3D video signal. The audio processor is configured to convert a 2D audio signal into a 3D audio signal according to a 3D positioning algorithm and the 3D computation power loading indicator. Images are displayed on the screen according to the 3D video signal. The sound reproducing apparatus is configured to generate dynamic 3D sound according to the 3D audio signal.

### BACKGROUND OF THE INVENTION

1. Field of the Invention

The present invention is related to a display system with sound reproduction and related method, and more particular to a display system with dynamic 3D sound reproduction and related method.

2. Description of the Prior Art

There are many ways to present a sound recording in a display system, as mono sound, stereophonic sound, or surround sound, etc. Mono sound is a single-channel audio reproduction which typically involves one microphone and one loudspeaker, or, in the case of multiple audio paths, mixing these audio paths into a single path. Stereophonic sound, commonly called stereo, is a dual-channel audio reproduction which typically involves a symmetrical configuration of loudspeakers in such a way so as to create the impression of sound heard from “screen channels” (center, front left, and front right), i.e. ca. 360° horizontal two-dimensional (2D) plane. Surround sound is a multi-channel audio reproduction which typically involves four or more loudspeakers for enriching the sound reproduction quality of an audio source according to a listener location or sweet spot where the audio effects work best. The multi-channel surround sound application encircles the audience with “surround channels” (left-surround, right-surround, back-surround) as in natural hearing.

Three-dimensional (3D) display technology provides more vivid visual experiences than traditional 2D display technology. The technique of reproducing 3D sound for use in a 3D display system has be developed in order to place sounds in particular locations around a viewer during a 3D video presentation, usually using a pair of loudspeakers or earphones. The 3D sound, also called virtual sound, is a dual-channel audio reproduction which creates the illusion of sound sources placed anywhere in 3D space, and is more economical than multi-channel audio reproduction of surround sound. The conversion of 2D audio signal into corresponding 3D audio signal involves 3D positioning algorithms based upon simulating psycho-acoustic cues, thereby replicating the way sounds are actually heard in 3D natural hearing.

FIG. 1 is a functional diagram of a prior art display system 100. The display system 100 is a 2D/3D compatible system and includes a 2D/3D video processor 110, a 2D/3D audio processor 120, a screen 130, a sound reproducing apparatus 140, and a user interface 150. The 2D/3D video processor 110 may convert a 2D video signal V_{2D} into a 3D video signal V_{3D}. The 2D/3D audio processor 120 may convert a 2D audio signal A_{2D} into a 3D audio signal A_{3D} based on a 3D positioning algorithm, such as one which creates virtual sound using psycho-acoustic cues. The viewer may switch between 2D/3D video modes or 2D/3D audio modes via the user interface 150. During a 3D video presentation, the viewer may select 3D audio mode in which the sound reproducing apparatus 140 generates 3D sound according to the 3D audio signal A_{3D}, or the viewer may select 2D audio mode in which the sound reproducing apparatus 140 generate 2D sound (mono, stereo or surround) according to the 2D audio signal A_{2D}.

In the prior art display system 100, the user interface 150 allows the viewer to enable 3D sound reproduction during a 3D video presentation. The prior art method of providing 3D sound is a predetermined process which is not associated with 3D video contents of the 3D video signal V_{3D}.

### SUMMARY OF THE INVENTION

The present invention provides a display system with dynamic 3D sound reproduction. The display system includes a video processor configured to convert a 2D video signal into a 3D video signal and acquire a 3D computation power loading indicator which is associated with 3D video contents of the 3D video signal; an audio processor configured to convert a 2D audio signal into a 3D audio signal according to a 3D positioning algorithm and the 3D computation power loading indicator; a screen for displaying images according to the 3D video signal; and a sound reproducing apparatus for generating audio sound according to the 3D audio signal.

The present invention provides a method for providing dynamic 3D sound in a display system. The method includes converting a 2D video signal into a 3D video signal; acquiring a 3D computation power loading indicator which is associated with 3D video contents of the 3D video signal; and converting a 2D audio signal into a 3D audio signal according to a 3D positioning algorithm and the 3D computation power loading indicator.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional diagram of a prior art display system.

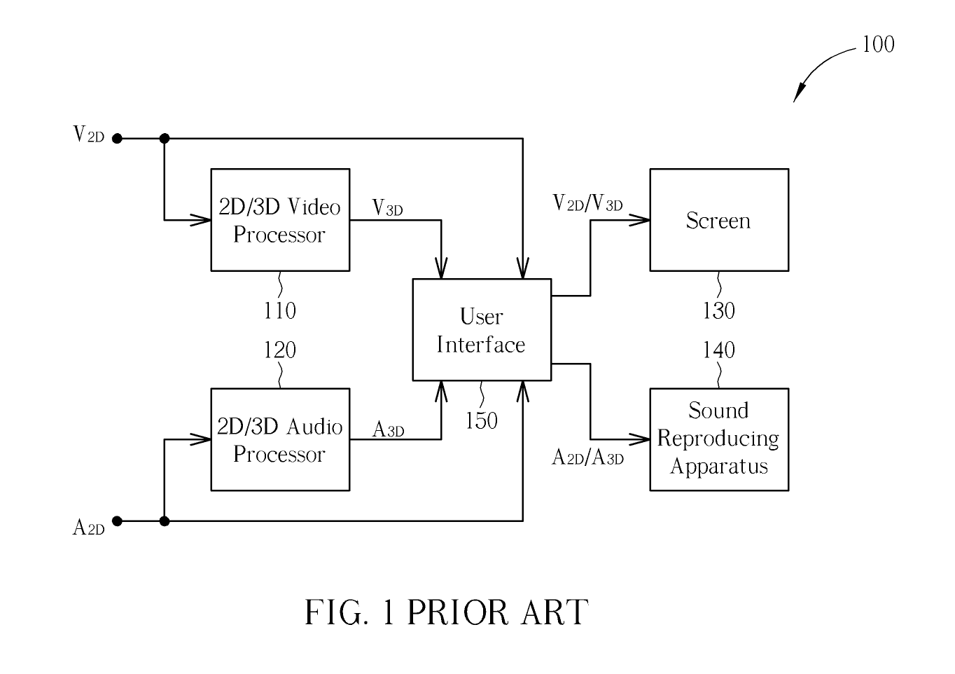

FIG. 2 is a functional diagram of a display system with dynamic 3D sound reproduction according to the present invention.

### DETAILED DESCRIPTION

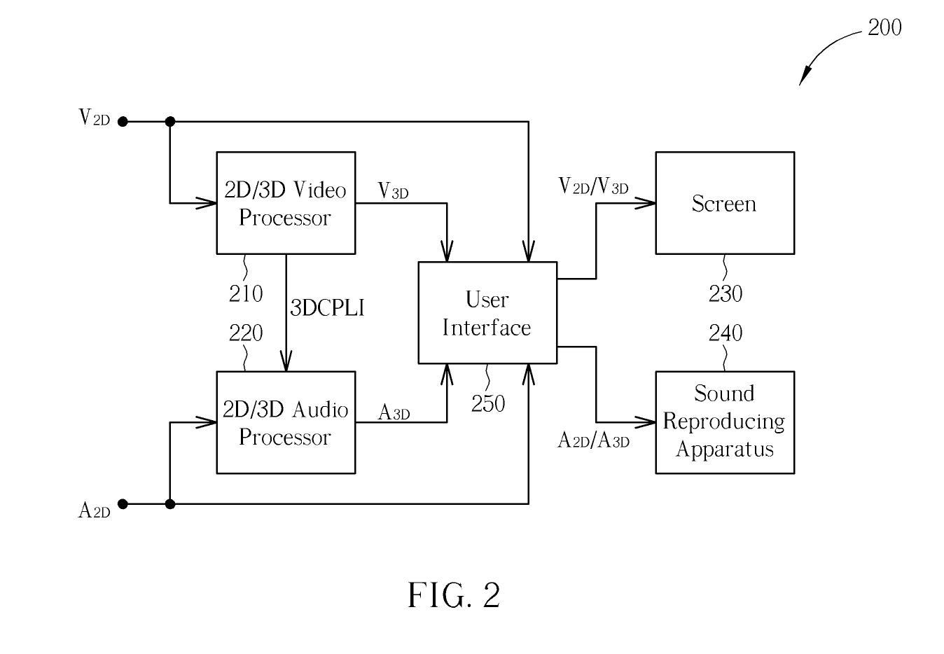

FIG. 2 is a functional diagram of a display system 200 with dynamic 3D sound reproduction according to the present invention. The display system 200 is a 2D/3D compatible system and includes a 2D/3D video processor 210, a 2D/3D audio processor 220, a screen 230, a sound reproducing apparatus 240, and a user interface 250. The 2D/3D video processor 210 is configured to convert a 2D video signal V_{2D} into a 3D video signal V_{3D} and acquire a 3D computation power loading indicator 3DCPLI which is associated with the 3D video contents of the 3D video signal V_{3D}, such as the quantity, size and depth of stereoscopic objects to be displayed in each region of the screen 230. A higher index of the 3D computation power loading indicator 3DCPLI associated with a specific frame in the 3D video signal V_{3D} indicates that there are more 3D video contents in the specific frame, which may involve displaying more stereoscopic objects or larger stereoscopic objects. In other word, if a specific frame has a higher index of the 3D computation power loading indicator 3DCPLI, the 2D/3D conversion of the specific frame requires more 3D computation.

The 2D/3D audio processor 220 of the present invention is configured to convert a 2D audio signal A_{2D} into a 3D audio signal A_{3D} based on a 3D positioning algorithm and the 3D computation power loading indicator 3DCPLI. The 3D positioning algorithm may be one which creates virtual sound by simulating psycho-acoustic cues, such as ITD (interaural time difference), IID (interaural intensity difference) and head-related transfer functions (HRTFs). When an audio source is at an arbitrary location in space, the sound wave arrives at both ears of the listener with different time delays due the unequal path length of wave propagation, thereby creating the ITD. Also, due to the head shadowing effects, the intensity of the sound waves arriving at both ears may be unequal, thereby creating the IID. The HRTF is used to describe the frequency-dependent amplitude and time-delay differences in perceived sound originating from a particular sound source that results from the complex shaping of the pinna at the left and right ear drums of the listener. By synthesizing the 3D audio signal A_{3D} using these psycho-acoustic cues, it allows the listener to perceive the motion of an object from the sound play back on the sound reproducing apparatus 240.

Also, the 2D/3D audio processor 220 may dynamically modulate the 3D audio signal A_{3D} according to the 3D computation power loading indicator 3DCPLI. Each frame of the 3D video signal V_{3D} may have different 3D video contents and thus require different amount of 3D computation. The present invention may enhance the 3D audio signal A_{3D} when the 3D video signal V_{3D} includes more 3D video contents, as indicated by a higher 3D computation power loading indicator 3DCPLI. By modulating the amplitude or phase of the 3D audio signal A_{3D} according to the 3D computation power loading indicator 3DCPLI, the virtual sound placed in a location where more 3D video contents (such as more stereoscopic objects or a larger stereoscopic object) are displayed may be intensified with respect to a location where fewer 3D video contents (such as fewer stereoscopic objects or a smaller stereoscopic object) are displayed. Therefore, the present invention may intensify human perception about the movement of the stereoscopic objects accordingly and provide a more realistic 3D environment.

The viewer may switch between 2D/3D video modes or 2D/3D audio modes via the user interface 250. During a 3D video presentation, the viewer may select 3D audio mode in which the sound reproducing apparatus 240 generate 3D sound according to the 3D audio signal A_{3D} and dynamically adjusts the reproduction of 3D sound according to the 3D video contents of each frame, or the viewer may select 2D audio mode in which the sound reproducing apparatus 240 generate 2D sound (mono, stereo or surround) according to the 2D audio signal A_{2D}. The user interface 250 may be an on-screen display (OSD) shown on the screen 230.

In the present invention, 3D sound is provided in a way so as to associate with the 3D video contents of the display images. Human perception about the movement of the displayed stereoscopic objects may be enhanced, thereby providing a more realistic 3D environment.

Those skilled in the art will readily observe that numerous modifications and alterations of the device and method may be made while retaining the teachings of the invention.

What is claimed is:

1. A display system with dynamic three-dimensional (3D) sound reproduction, comprising:
a video processor configured to convert a two-dimensional (2D) video signal into a 3D video signal and acquire a 3D computation power loading indicator which is associated with 3D video contents of the 3D video signal;
an audio processor configured to convert a 2D audio signal into a 3D audio signal according to a 3D positioning algorithm and the 3D computation power loading indicator;
a screen for displaying images according to the 3D video signal; and
a sound reproducing apparatus for generating audio sound according to the 3D audio signal.

2. The display system of claim 1, wherein the audio processor is further configured to modulate an amplitude or a phase of the 3D audio signal according to the 3D computation power loading indicator.

3. The display system of claim 1, further comprising:
a user interface for allowing a viewer to select between a 2D mode in which the sound reproducing apparatus generates the audio sound according to the 2D audio signal and a 3D mode in which the sound reproducing apparatus generates the audio sound according to the 3D audio signal.

4. The display system of claim 3, wherein the user interface is an on-screen display (OSD) shown on the screen.

5. A method for providing dynamic 3D sound in a display system, comprising:
converting a 2D video signal into a 3D video signal;
acquiring a 3D computation power loading indicator which is associated with 3D video contents of the 3D video signal; and
converting a 2D audio signal into a 3D audio signal according to a 3D positioning algorithm and the 3D computation power loading indicator.

6. The method of claim 5, wherein converting the 2D audio signal into the 3D audio signal includes modulating an amplitude or a phase of the 3D audio signal according to the 3D computation power loading indicator.

7. The method of claim 5, wherein converting the 2D audio signal into the 3D audio signal is according to the 3D positioning algorithm which creates virtual sound by simulating psycho-acoustic cues.

8. The method of claim 5, further comprising acquiring the 3D computation power loading indicator according to a size of a stereoscopic object, a depth of a stereoscopic object, or an amount of stereoscopic objects to be displayed according to the 3D video signal.
